(19) United States
(12) Patent Application Publication
(10) Pub. No.: US 2026/0135964 A1
(43) Pub. Date: May 14, 2026

(54) IMAGE READING APPARATUS AND IMAGE FORMING APPARATUS

(71) Applicant: CANON KABUSHIKI KAISHA, Tokyo (JP)

(72) Inventor: KENJI OOKI, Chiba (JP)

(21) Appl. No.: 19/371,583

(22) Filed: Oct. 28, 2025

(30) Foreign Application Priority Data
Nov. 13, 2024 (JP) 2024-198204

(51) Int. Cl. H04N 1/00

(52) U.S. Cl. CPC H04N 1/00992; H04N 1/00037; H04N 1/00408; H04N 1/00551

(57) ABSTRACT

An image reading apparatus includes a transparent member, a reading unit configured to read an image on a document through the transparent member, an opening/closing unit disposed to be openable and closable with respect to the transparent member, and a controller configured to acquire environmental information including at least one of temperature and humidity, and configured to cause a display unit to display an indication prompting an opening of the opening/closing unit based on the environmental information.

### BACKGROUND

### Field of the Technology

This disclosure relates to an image reading apparatus that reads an image of a document, and an image forming apparatus that forms the image on a sheet.

### Description of the Related Art

Hitherto, image reading apparatuses are configured with a casing equipped with a glass transparent plate (platen glass) on an upper surface on which documents are placed, and a light source for illumination and a reading unit for reading images on the documents are disposed inside the casing. In such image reading apparatuses, there is a risk that dew condensation may occur internally depending on an installation environment, and defects such as distortion in read images may result.

For this reason, an apparatus is proposed that, in a case where an internal or external temperature and humidity sensor detects environments where the dew condensation is likely to occur, eliminates the dew condensation by warming an interior of the apparatus using a heater or dissipating stagnant air inside the apparatus with a fan (refer to Japanese Patent Laid-Open No. 2005-181779).

In conventional image reading apparatuses, a configuration is utilized in which heaters and fans are disposed to prevent the dew condensation. Therefore, in the conventional image reading apparatuses, there is an issue that the apparatuses may increase in size due to the necessity for space for disposing heaters and fans, and the necessity for these components may increase the number of components and thus result in increased costs.

### SUMMARY

Therefore, this disclosure aims to provide an image reading apparatus and an image forming apparatus that can suppress increases in the number of components and costs associated with countermeasures against the dew condensation.

According to a first aspect of the present disclosure, an image reading apparatus includes a transparent member, a reading unit configured to read an image on a document through the transparent member, an opening/closing unit disposed to be openable and closable with respect to the transparent member, and a controller configured to acquire environmental information including at least one of temperature and humidity, and configured to cause a display unit to display an indication prompting an opening of the opening/closing unit based on the environmental information.

According to a second aspect of the present disclosure, an image forming apparatus includes an image reading apparatus configured to read an image on a document, an image forming apparatus body configured to form the image on a recording medium, and a display unit configured to display information. the image reading apparatus includes a transparent member, a reading unit configured to read the image on the document through the transparent member, an opening/closing unit disposed to be openable and closable with respect to the transparent member, and a first controller configured to transmit image information that has been read by the reading unit. The image forming apparatus body includes an environmental sensor configured to detect environmental information including at least one of temperature and humidity, a second controller configured to receive the image information transmitted by the first controller, and an image forming unit configured to form the image on a sheet based on the image information received by the second controller. The first controller is configured to cause the display unit to display an indication prompting an opening of the opening/closing unit.

According to a third aspect of the present disclosure, an image forming apparatus includes an image reading apparatus configured to read an image on a document, an image forming apparatus body configured to form the image on a recording medium, and a display unit configured to display information. the image reading apparatus includes a transparent member, a reading unit configured to read the image on the document through the transparent member, an opening/closing unit disposed to be openable and closable with respect to the transparent member, and a first controller configured to transmit image information that has been read by the reading unit. The image forming apparatus body includes an environmental sensor configured to detect environmental information including at least one of temperature and humidity, a second controller configured to receive the image information transmitted by the first controller, and an image forming unit configured to form the image on a sheet based on the image information received by the second controller. The second controller is configured to cause the display unit to display an indication prompting an opening of the opening/closing unit based on the environmental information.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating a printer according to an embodiment of this disclosure.

FIG. 2 is a perspective view illustrating an automatic image reading apparatus according to the embodiment of this disclosure.

FIG. 3 is a cross-sectional view illustrating an automatic document feeder (ADF) according to the embodiment of this disclosure.

FIG. 4 is a front view illustrating an operation unit according to the embodiment of this disclosure.

FIG. 5 is a diagram illustrating a configuration example of a reader controller and a system controller according to the embodiment of this disclosure.

FIG. 6 is a flowchart illustrating processes relating to countermeasures against dew condensation prevention and dew condensation occurrence, which are performed in a case of activating the image reading apparatus according to the embodiment of this disclosure.

FIG. 7 is a diagram illustrating a relationship between temperature and humidity conditions under which dew condensation is likely to occur according to the embodiment of this disclosure.

FIG. 8 is a diagram illustrating an example of the transition of an external temperature of the image reading apparatus according to the embodiment of this disclosure, and elapsed time.

FIG. 9 is a diagram illustrating an example of an indication displayed on the operation unit according to the embodiment of this disclosure for prompting an opening of the ADF for the dew condensation prevention.

FIG. 10 is a diagram illustrating an example of an indication displayed on the operation unit according to the embodiment of this disclosure for prompting the opening of the ADF for the elimination of the dew condensation.

FIG. 11 is a diagram illustrating a configuration example of a reader controller and a system controller according to a modification example of this disclosure.

### DESCRIPTION OF THE EMBODIMENTS

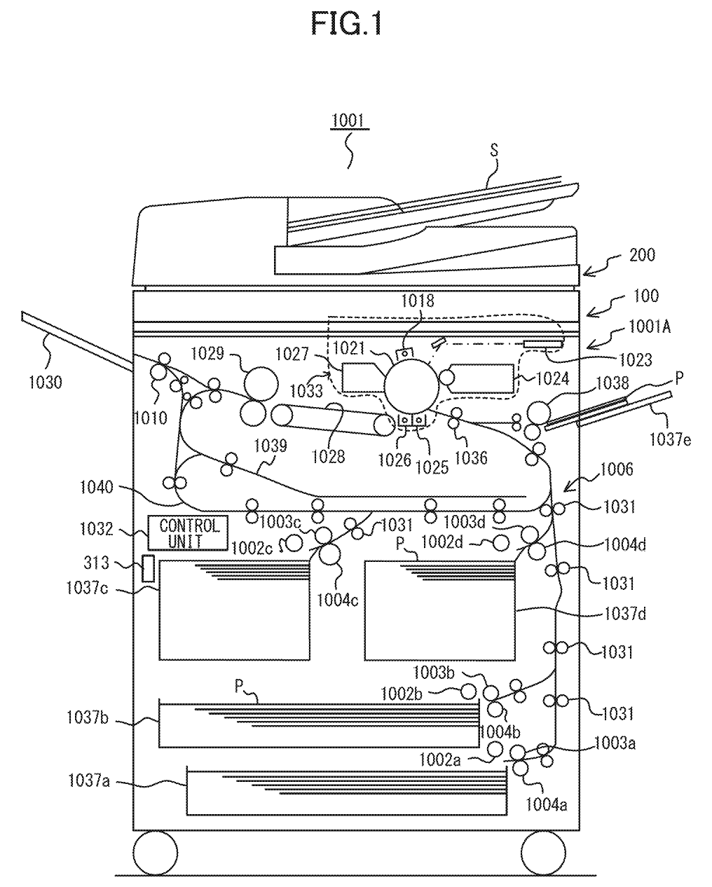

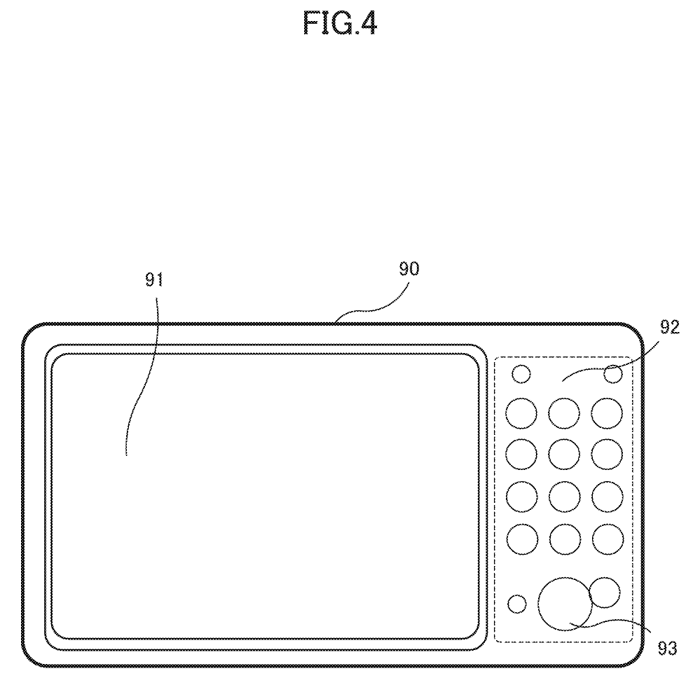

Hereinafter, with reference to drawings, an embodiment according to this disclosure will be described in detail. FIG. 1 is a cross-sectional view illustrating a printer 1001, serving as an image forming apparatus according to this embodiment. To be noted, in the following, a side on which a user faces an operation unit 90 (refer to FIG. 4) to input or configure various settings with respect to the printer 1001 is defined as the “front side” of the printer 1001, and the opposite side is defined as the “rear side”. That is, FIG. 1 illustrates an internal configuration of the printer 1001 as viewed from the front side.

### Schematic Configuration of Printer

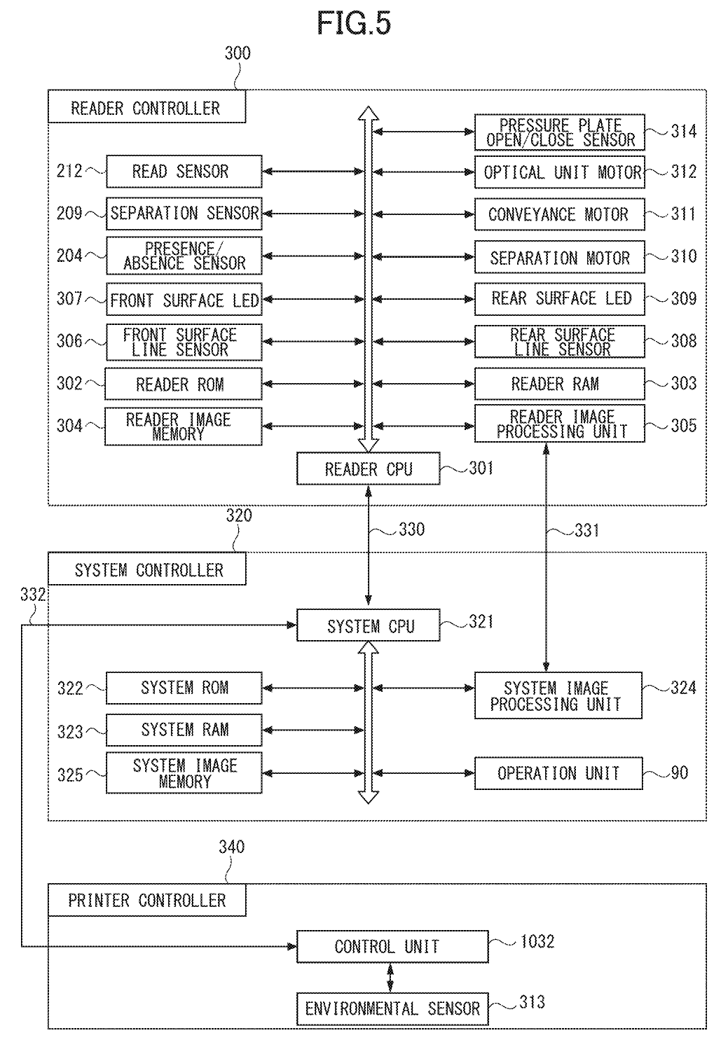

As illustrated in FIG. 1, in the printer 1001, an image reading apparatus 100 is arranged on top of a printer body 1001A, serving as an image forming apparatus body. The image reading apparatus 100 optically scans a document S to read image information. The image information that has been converted to an electrical signal by the image reading apparatus 100 is transferred via a system controller 320 (refer to FIG. 5) to a control unit 1032 (refer to FIG. 5) of a printer controller 340 disposed in the printer body 1001A. Thereby, the printer 1001 forms an image on a recording medium based on the image information read by the image reading apparatus 100.

The printer body 1001A includes an image forming unit 1033 that forms the image on a sheet P, serving as the recording medium, and a sheet feed unit 1006 that feeds the sheet P to the image forming unit 1033. The sheet feed unit 1006 includes sheet storage units 1037a, 1037b, 1037c, and 1037d that can store sheets of each different size. The sheets stored in each sheet storage unit are fed by respective pickup rollers 1002a, 1002b, 1002c, and 1002d. Then, the sheets are separated into one sheet at a time by feed rollers 1003a, 1003b, 1003c, and 1003d and retard rollers 1004a, 1004b, 1004c, and 1004d, and are delivered to corresponding conveyance roller pairs 1031.

The sheet P is sequentially delivered by the plurality of conveyance roller pairs 1031 that are arranged along sheet conveyance paths from the sheet feed units, in which the sheet P is stored, and, thereby, is conveyed to a registration roller pair 1036.

To be noted, the sheet P placed on a manual feed tray 1037e by the user is fed into the printer body 1001A by a sheet feed roller 1038, and is conveyed to the registration roller pair 1036. The registration roller pair 1036 halts a leading edge of the sheet P to correct skew, and resumes the conveyance of the sheet P in synchronization with the progress of an image forming operation, which is a formation process of a toner image by the image forming unit 1033.

The image forming unit 1033, which forms the image on the sheet P, is a unit of an electrophotographic system including a photosensitive drum 1021, serving as a photosensitive member. To be noted, the image forming unit 1033 is an example of an image forming means, and may be configured from, for example, an inkjet-type image forming unit or an offset printing-type printing mechanism.

The photosensitive drum 1021 is capable of rotating along a conveyance direction of the sheet P, and a charge unit 1018, an exposing unit 1023, a developing unit 1024, a transfer charge unit 1025, a separation charge unit 1026, and a cleaner 1027 are arranged around the photosensitive drum 1021. The charge unit 1018 uniformly charges a surface of the photosensitive drum 1021. The exposing unit 1023 exposes the photosensitive drum 1021 based on the image information input from the image reading apparatus 100 and the like, and forms an electrostatic latent image on the photosensitive drum 1021.

The developing unit 1024 accommodates a two-component developer containing toner and a carrier, and develops the electrostatic latent image into the toner image by supplying charged toner to the photosensitive drum 1021. The toner image borne on the photosensitive drum 1021 is transferred onto the sheet P conveyed from the registration roller pair 1036 by a bias electric field generated by the transfer charge unit 1025. The sheet P onto which the toner image has been transferred is separated from the photosensitive drum 1021 by a bias electric field generated by the separation charge unit 1026, and is conveyed toward a fixing unit 1029 by a pre-fixing conveyance unit 1028. To be noted, adherent materials such as transfer residual toner not transferred onto the sheet P and remaining on the photosensitive drum 1021 are collected by the cleaner 1027, and the photosensitive drum 1021 prepares for a subsequent image forming operation.

The sheet P conveyed to the fixing unit 1029 is nipped by a roller pair, and is heated under pressure; thus, the image is fixed through melting and bonding of the toner. In a case where image output has been completed, the sheet P which has obtained the fixed image is discharged via a sheet discharge roller pair 1010 to a sheet discharge tray 1030, which extends outward from the printer body 1001A. In a case of forming the image on the rear side of the sheet P in duplex printing, the sheet P, which has passed through the fixing unit 1029, is conveyed to the registration roller pair 1036 through a duplex conveyance portion 1040 with its front and rear sides interchanged by a reverse portion 1039. Then, the sheet P on which the image has again been formed by the image forming unit 1033 is discharged to the sheet discharge tray 1030.

An environmental sensor 313, serving as a detection unit disposed adjacent to an exterior cover, detects one or both of the ambient air temperature and humidity. In other words, the environmental sensor 313 is configured to detect environmental information including one or both of temperature and humidity external to the image reading apparatus 100 and the printer body 1001A. To be noted, the environmental sensor 313 may be arranged at other locations, and, for example, may be situated adjacent to the image forming unit 1033 within the printer body 1001A to detect an internal temperature and humidity of the printer body 1001A.

The control unit 1032 performs the control of the heating temperature of the fixing unit 1029 based on detection results detected by the environmental sensor 313. In addition, the detection results detected by the environmental sensor 313 are transmitted via a system central processing unit (CPU) 321 (refer to FIG. 5) to a reader CPU 301 (refer to FIG. 5), and are referenced during countermeasures against dew condensation prevention and dew condensation occurrence described below.

### Configuration of Automatic Image Reading Apparatus

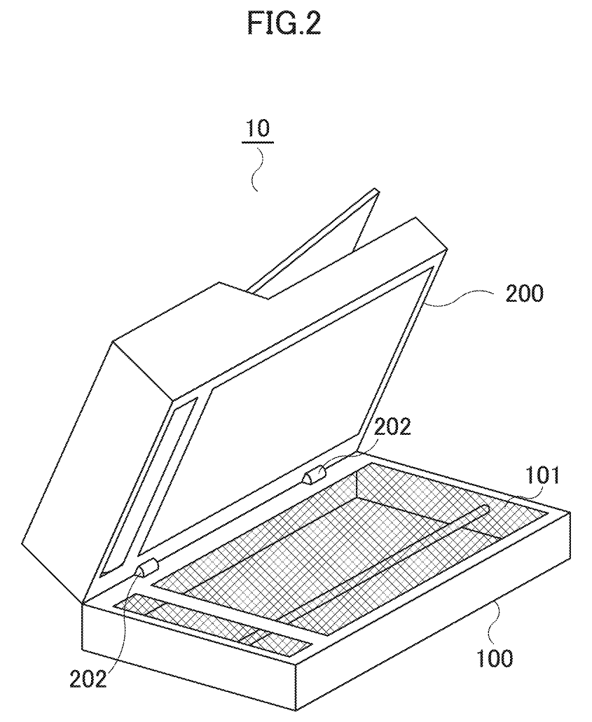

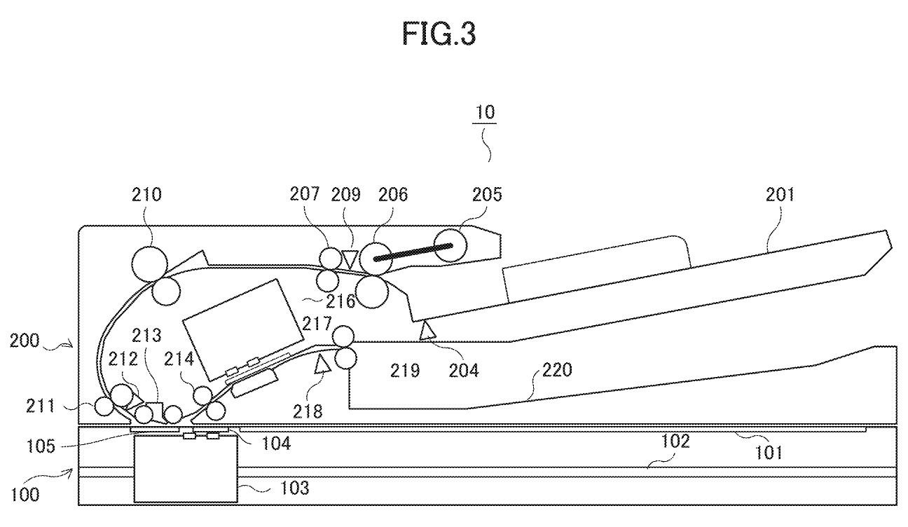

With reference to FIG. 2, an automatic image reading apparatus 10 will be described. FIG. 2 is a perspective view illustrating the automatic image reading apparatus 10 in this embodiment. The automatic image reading apparatus 10 in this embodiment includes the image reading apparatus 100 that reads the document, and an automatic document conveyance apparatus (hereinafter, also referred to as an automatic document feeder (ADF)) 200 that conveys the document toward the image reading apparatus 100. In addition, a reader controller 300 (refer to FIG. 5) and the system controller 320 (refer to FIG. 5) are connected to the automatic image reading apparatus 10. The ADF 200 is connected to the image reading apparatus 100 via an open/close hinge 202 disposed on the rear side of an upper surface of the image reading apparatus 100 so as to be openable and closable with respect to the image reading apparatus 100. In other words, the ADF 200, serving as an opening/closing unit, is disposed to be openable and closable with respect to a platen glass 101 (refer to FIG. 3) of the image reading apparatus 100.

### Configuration of Image Reading Apparatus

Next, with reference to FIG. 3, the image reading apparatus 100 will be described. FIG. 3 is a cross-sectional view illustrating the ADF 200 in this embodiment. The image reading apparatus 100 includes the platen glass 101, serving as a pressure plate glass and a transparent member, a reading movement guide 102, a front surface reading unit 103, serving as a reading unit, a white reference plate 104, and an optical unit motor 312 (refer to FIG. 5). In document reading control, the image reading apparatus 100 reads a surface of the document placed on the platen glass 101 one line at a time while moving the front surface reading unit 103 along the reading movement guide 102 using the optical unit motor 312. Thereby, the image reading apparatus 100 reads the image of the surface of the document via the platen glass 101. In addition, during document feeding-reading control for reading the image from the document which is conveyed by the ADF 200, the image of the document, which is conveyed onto a front surface feeding-reading glass 105 by the ADF 200, is read by the front surface reading unit 103 via the front surface feeding-reading glass 105.

### Configuration of Automatic Document Conveyance Apparatus

Next, with reference to FIG. 3, the ADF 200 will be described. The ADF 200 includes a document tray 201 for placing a document stack including equal to or more than one document sheet. In addition, the ADF 200 includes a separation roller pair 206, serving as a separation mechanism, that regulates the document stack so as not to protrude from the document tray 201 and enter downstream before the initiation of the conveyance of the document, and a pickup roller 205. On the document tray 201, a document presence/absence sensor 204 is arranged to detect the presence/absence of the document stack on the document tray 201.

In the ADF 200, by rotating a separation motor 310 (refer to FIG. 5) and a conveyance motor 311 (refer to FIG. 5), the pickup roller 205 is lowered onto an uppermost surface of the document stack placed on the document tray 201, and is rotated. Thereby, the document on the uppermost surface of the document stack is fed to the separation roller pair 206. For the document delivered by the pickup roller 205, a single sheet on the uppermost surface is separated and conveyed by the action of the separation roller pair 206, which is driven by the separation motor 310. The separation of the document on the uppermost surface of the document stack by the action of the separation roller pair 206 is achieved through known separation technology.

The document separated by the separation roller pair 206 is sent to an extraction roller pair 207. A separation sensor 209 is arranged in a conveyance path downstream of the separation roller pair 206. In the ADF 200, the separation motor 310 is stopped after the extraction roller pair 207 has started the conveyance of the document based on the timing at which the separation sensor 209 detects the leading edge of the document, and the feeding of the document terminates.

Downstream of the extraction roller pair 207, a conveyance path for conveying the document in a direction in which the front surface feeding-reading glass 105, on which reading of the front surface of the document passed through the extraction roller pair 205 is performed, and a rear surface feeding-reading glass 217, on which reading of a rear surface of the aforementioned document is performed, are disposed. The document sent to the conveyance path is conveyed to the front surface feeding-reading glass 105 by the extraction roller pair 207, a conveyance roller pair 210, and a read upstream roller pair 211.

A read sensor 212 is arranged upstream of the front surface feeding-reading glass 105 in the conveyance direction of the document. In the ADF 200, the front surface reading unit 103 performs the reading of the front surface of the document based on the timing at which the read sensor 212 detects the leading edge of the document. In the ADF 200, during the reading of the front surface of the document by the front surface reading unit 103, light is irradiated onto the document passing over the front surface feeding-reading glass 105 from beneath the front surface feeding-reading glass 105 by a front surface light emitting diode (LED) 307 (refer to FIG. 5). In the ADF 200, the front surface LED 307 irradiates the document, and a front surface line sensor 306 (refer to FIG. 5) reads light reflected from the front surface of the document through a surface mirror and lens; thus, the image of the front surface of the document is read.

The document whose image of the front surface has been read by the front surface reading unit 103 is conveyed to the rear surface feeding-reading glass 217 by a read downstream roller pair 214. In a case where duplex reading is performed, in the ADF 200, first, as described above, the image on the front surface is read by the front surface reading unit 103. Next, in the ADF 200, based on the timing at which the read sensor 212 detects the leading edge of the document, the rear surface of the document is read by a rear surface reading unit 216. In the ADF 200, during the reading of the rear surface of the document by the rear surface reading unit 216, light is irradiated onto the document passing beneath the rear surface feeding-reading glass 217 from above the rear surface feeding-reading glass 217 by a rear surface LED 309 (refer to FIG. 5). In the ADF 200, the rear surface LED 309 irradiates the document, and a rear surface line sensor 308 (refer to FIG. 5) reads light reflected from the rear surface of the document through a surface mirror and lens; thus, the image of the rear surface of the document is read.

The document that has been read is discharged onto a document discharge tray 220 by a document discharge roller pair 219. A document discharge sensor 218 is arranged upstream of the document discharge roller pair 219 in the conveyance direction of the document. In the ADF 200, in a case where there are no documents present on the document tray 201, based on the timing at which the document discharge sensor 218 detects a trailing edge of the document, the conveyance motor 311 is stopped after the discharge of the document has been completed, and the reading of the document terminates.

### Configuration of Operation Unit

Next, with reference to FIG. 4, the operation unit 90 will be described. FIG. 4 is a front view illustrating the operation unit 90 disposed in the automatic image reading apparatus 10 of this embodiment. The operation unit 90 includes a display unit 91, such as a liquid crystal panel, and a set of operation keys 92, serving as an input portion. The set of the operation keys 92 includes an image reading execution button 93. The operation unit 90 is electrically connected to the system controller 320 (refer to FIG. 5) that performs the overall control of the apparatus. The display unit 91 of this embodiment is configured from a touch panel capable of accepting an operation by the user.

### Description of Block Diagram and System Configuration Diagram

FIG. 5 is a diagram illustrating a configuration example of the reader controller 300 and the system controller 320, which serve as control units connected to the automatic image reading apparatus 10 in this embodiment. As illustrated in FIG. 5, in this embodiment, the system is configured such that the reader controller 300, the system controller 320, and the printer controller 340 are electrically connected.

As illustrated in FIG. 5, the reader controller 300 includes a reader central processing unit (CPU) 301 and a reader read only memory (ROM) 302. In addition, the reader controller 300 includes a reader random access memory (RAM) 303. Control programs are stored in the reader ROM 302, and input data and working data are stored in the reader RAM 303. The reader CPU 301 controls the automatic image reading apparatus 10 by executing a flow of the control programs stored in the reader ROM 302.

In addition, to implement an image reading function, the optical unit motor 312, the front surface LED 307, the rear surface LED 309, the front surface line sensor 306, and the rear surface line sensor 308 are connected to the reader CPU 301. The reader CPU 301 stores the image of the front surface of the document read by the front surface line sensor 306 in a reader image memory 304 as image data. In addition, the reader CPU 301 stores the image of the rear surface of the document read by the rear surface line sensor 308 in the reader image memory 304 as image data.

In addition, a pressure plate open/close sensor 314 that detects the opening and closing of the ADF 200 with respect to the image reading apparatus 100 is connected to the reader CPU 301. The pressure plate open/close sensor 314 is arranged adjacent to the open/close hinge 202 which connects the ADF 200 to be freely openable and closable with respect to the image reading apparatus 100. The pressure plate open/close sensor 314 detects a closed state of the ADF 200 by electrically detecting that a projection, not shown, is pressed when closing the ADF 200 using the open/close hinge 202 as a rotation axis. In addition, the pressure plate open/close sensor 314 detects an open state of the ADF 200 in a case where the ADF 200 is opened and, thereby, the pressing of the projection is released.

The reader CPU 301 receives an image output request transmitted from the system controller 320 via a command data bus 330. In response to the received image output request, the reader CPU 301 performs various image processing operations on the image data stored in the reader image memory 304 using a reader image processing unit 305, and then transmits the processed image data to the system controller 320 via an image data bus 331. In other words, the reader CPU 301, serving as a first control unit, transmits the image data (image information), which have been read by the front surface reading unit 103 and the rear surface reading unit 216, to a system CPU 321.

Further, via the image data bus 331, the reader CPU 301 transmits a vertical sync signal that serves as a reference for a leading edge of the image data, and a horizontal sync signal that serves as a reference for a leading edge of each line of pixels to the system controller 320 in synchronization with the timing of the reading of the image of the document.

The system controller 320 includes the system CPU 321, a system ROM 322, and a system RAM 323, and transmits and receives data relating to the image reading control to and from the reader CPU 301 via the command data bus 330. In addition, a system image processing unit 324 and a system image memory 325 are connected to the system CPU 321. Using the system image processing unit 324, the system CPU 321 performs various image processing operations on the image data received via the image data bus 331, and, thereafter, stores the processed image data in the system image memory 325. In addition, the system controller 320 includes the operation unit 90, and receives the input from the user via the operation unit 90.

As illustrated in FIG. 5, the control unit 1032 is connected to the system CPU 321 via a print system bus 332. The system CPU 321 exchanges control commands required for printing with the control unit 1032.

The printer controller 340 includes the control unit 1032. The control unit 1032 performs the control of the overall operation of the printer 1001. In addition, the control unit 1032 controls the operation of the image forming unit 1033. The image forming unit 1033 acquires the image data from the system image memory 325, and forms the image in accordance with the image data by controlling the exposing unit 1023 and the developing unit 1024 based on the acquired image data. The system CPU 321, which receives the image data from the reader CPU 301, and the control unit 1032, which controls the image forming unit 1033 based on the image data received by the system CPU 321, constitute a second controller in this embodiment.

In addition, the environmental sensor 313 is connected to the control unit 1032. The control unit 1032 acquires one or both of the detection results of the ambient air temperature and humidity detected by the environmental sensor 313, and utilizes them for the control of the fixing unit 1029 and the like. Then, it is configured such that the detection results of the environmental sensor 313 can be referenced also by the system CPU 321 and the reader CPU 301 via communication links.

Process Flow for Countermeasures against Dew Condensation Prevention and Dew Condensation Occurrence in Image Reading Apparatus

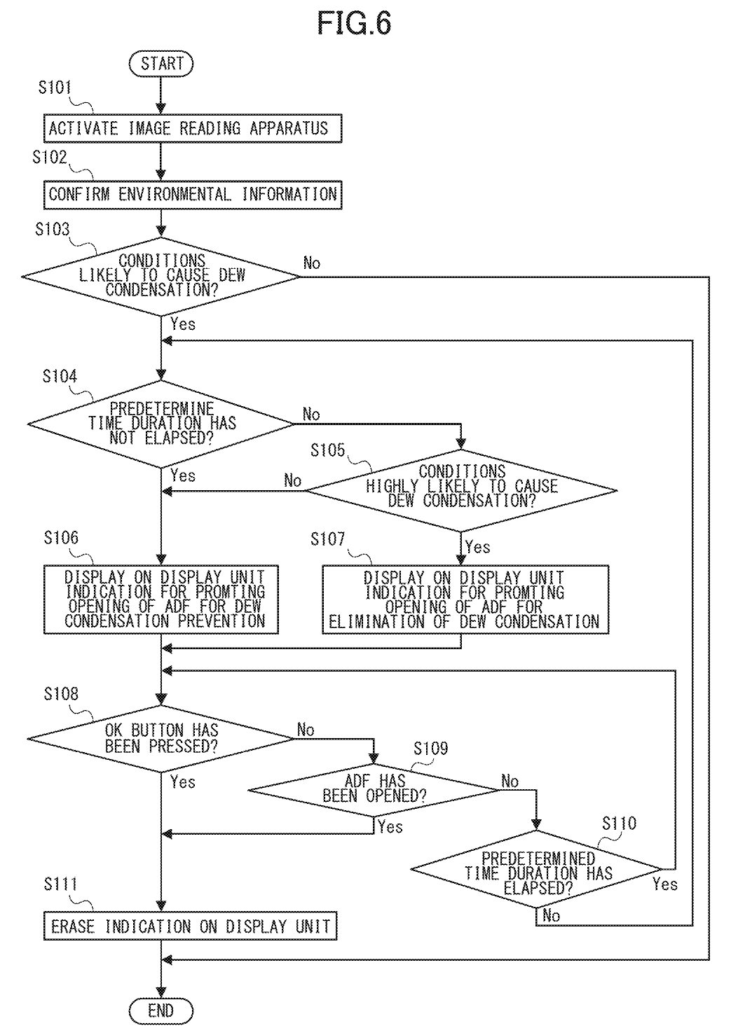

Next, with reference to FIG. 6, a process flow relating to the countermeasures against the dew condensation prevention and the dew condensation occurrence in the image reading apparatus 100, which the reader controller 300 of the image reading apparatus 100 executes, will be described. FIG. 6 is a flowchart illustrating processes relating to the countermeasures against the dew condensation prevention and the dew condensation occurrence, which are executed when the image reading apparatus 100 is activated. Each process illustrated in the flowchart of FIG. 6 is executed by the reader CPU 301 of the reader controller 300.

As illustrated in FIG. 6, when the image reading apparatus 100 is activated (STEP S101), the reader CPU 301 starts the processes relating to the countermeasures against the dew condensation prevention and the dew condensation occurrence. The reader CPU 301 receives the detection results detected by the environmental sensor 313 from the system CPU 321 (STEP S102). In this process, the reader CPU 301 confirms the environmental information: the ambient air temperature and humidity, which are the detection results of the environmental sensor 313, and confirms environmental conditions (environmental state) surrounding the image reading apparatus 100.

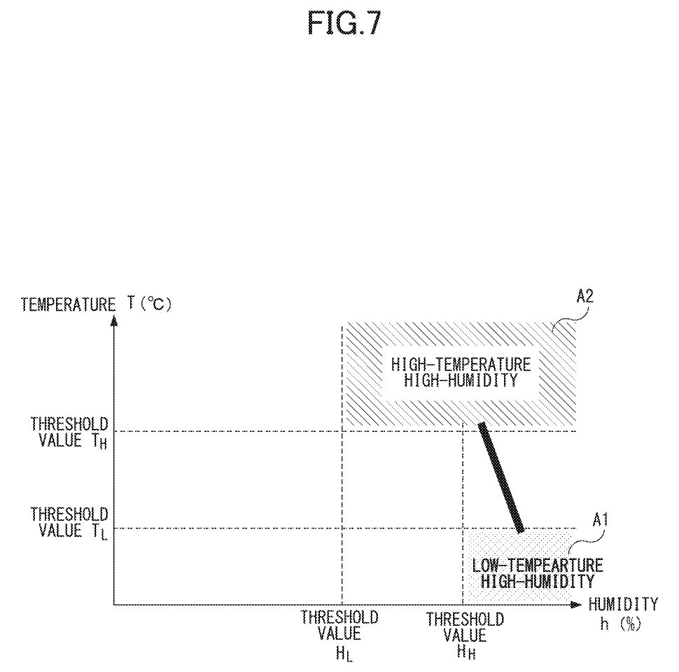

Next, the reader CPU 301 determines whether or not the environmental conditions at the time at which the image reading apparatus 100 is activated are likely to cause the dew condensation (STEP S103). Details of the process of STEP S103 will be described using FIG. 7.

FIG. 7 is a diagram illustrating a relationship between temperature and humidity at which the dew condensation is likely to occur. As illustrated in FIG. 7, a region A1 corresponds to a low-temperature, high-humidity area, in which the temperature is equal to or less than a threshold value T_{L}, serving as a first threshold value, (equal to or less than the first threshold value) and the humidity is equal to or greater than a threshold value H_{H}, serving as a second threshold value, (equal to or greater than the second threshold value). In the image reading apparatus 100, in a case where the environmental information confirmed upon the activation is within a range of the region A1, conditions likely to cause the dew condensation are present. In this embodiment, the threshold value T_{L} is set to a temperature of 5°C, and the threshold value H_{H} is set to a humidity of 80%.

In a case where it is determined that the environmental information confirmed in the process of STEP S103 is outside the range of the region A1 illustrated in FIG. 7 (STEP S103: No), the reader CPU 301 determines that the conditions are not likely to cause the dew condensation and terminates the processes relating to the countermeasures against the dew condensation prevention and the dew condensation occurrence. That is, in the case where the confirmed environmental information is outside the range of the region A1 illustrated in FIG. 7, the reader CPU 301 does not display an indication prompting an opening of the ADF 200, described below, on the display unit 91. On the other hand, in a case where it is determined that the environmental information confirmed in the process of STEP S103 is within the range of the region A1 illustrated in FIG. 7 (STEP S103: Yes), the reader CPU 301 determines that the conditions are likely to cause the dew condensation and advances the process to STEP S104.

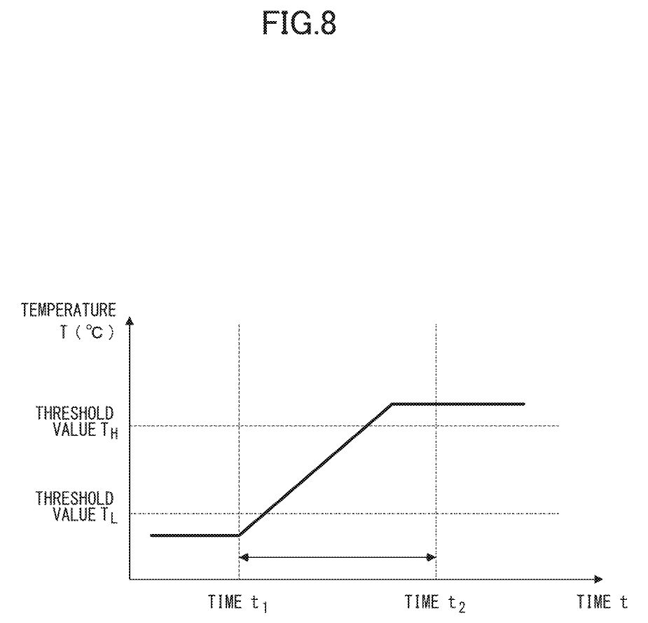

In the process of STEP S104, the reader CPU 301 determines whether or not a predetermined time duration has elapsed (STEP S104). The predetermined time duration will be described using FIG. 8. FIG. 8 is a diagram illustrating an example of the transition of temperature outside the image reading apparatus 100 and the elapse of time. In the image reading apparatus 100, in a case where the temperature rises from the temperature upon the activation of the apparatus to a temperature equal to or greater than a threshold value T_{H}, serving as a third threshold value, the likelihood of the dew condensation occurrence increases at a time when the elapsed time has reached the predetermined time duration. In this embodiment, the threshold value T_{H} is set to a temperature of 25°C, which is higher than 5°C, and the predetermined time duration is set to a duration of 80 minutes, which corresponds to a time duration from a time t1 to a time t2 illustrated in FIG. 8.

In the process of STEP S104, in a case where it is determined that the predetermined time duration has not elapsed (STEP S104: Yes), the reader CPU 301 determines that the conditions are likely to cause the dew condensation and advances the process to STEP S106. On the other hand, in the process of STEP S104, in a case where it is determined that the predetermined time duration has elapsed (STEP S104: No), the reader CPU 301 determines whether or not the environmental conditions after the expiration of the predetermined time duration are highly likely to cause the dew condensation (STEP S105). Details of the process of STEP S105 will be described using FIG. 7.

As illustrated in FIG. 7, a region A2 corresponds to a high-temperature, high-humidity area, in which the temperature is equal to or greater than a threshold value T_{H}, and the humidity is equal to or greater than a threshold value H_{L}, serving as a fourth threshold value, which is less than the threshold value H_{H}. In a case where the environmental information within the range of the region A2 is confirmed after the predetermined time duration has elapsed since the environmental information within the range of the region A1 was confirmed upon activation, the image reading apparatus 100 enters a state in which there exists a high likelihood that the dew condensation has occurred. In this embodiment, the threshold value H_{L} is set to a humidity of 60%.

In a case where the environmental information confirmed in the process of STEP S105 is outside the range of the region A2 illustrated in FIG. 7 (STEP S105: No), the reader CPU 301 determines that there exists a low likelihood that the dew condensation is occurring and advances the process to STEP S106. On the other hand, in a case where the environmental information confirmed in the process of STEP S105 is within the range of the region A2 illustrated in FIG. 7 (STEP S105: Yes), the reader CPU 301 determines that it is a state in which the dew condensation occurrence can be predicted to have occurred and advances the process to STEP S106.

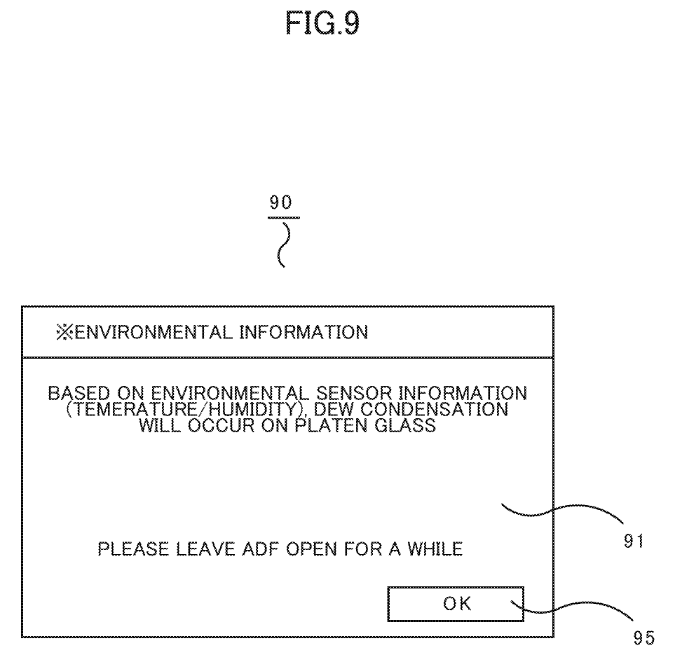

In the process of STEP S106, since the environmental conditions upon the activation were likely to cause the dew condensation, the reader CPU 301 displays the indication prompting the opening of the ADF 200 on the display unit 91 for the dew condensation prevention (STEP S106). Details of the process of STEP S106 will be described using FIG. 9.

FIG. 9 is a diagram illustrating an example of the indication displayed on the display unit 91 prompting the opening of the ADF 200 for the dew condensation prevention. As illustrated in FIG. 9, the reader CPU 301 displays the indication on the display unit 91 prompting the opening of the ADF 200 to prevent the dew condensation which occurs on the platen glass 101 (refer to FIG. 2). In addition, the reader CPU 301 displays an OK button 95, which is a button for accepting a termination operation of terminating the indication prompting the opening of the ADF 200 for the dew condensation prevention, on the display unit 91.

Since it is a state in which the dew condensation can be predicted to occur on the platen glass 101, as the indication prompting the opening of the ADF 200 for the dew condensation prevention, for example, the following indication may be displayed: “Based on environmental sensor information (temperature/humidity), dew condensation will occur on the platen glass.” In addition, as the indication prompting the opening of the ADF 200 for the dew condensation prevention, for example, an indication such as, “Please leave the ADF open for a while,” will be displayed. This indication prompting the opening of the ADF 200 for the dew condensation prevention illustrated in FIG. 9 serves as a first indication in this embodiment.

To be noted, in a case where the reader CPU 301 has already executed the process of STEP S106 and the indication prompting the opening of the ADF 200 for the dew condensation prevention is being displayed on the display unit 91, the reader CPU 301 advances the process to STEP S107 while maintaining the indication on the display unit 91.

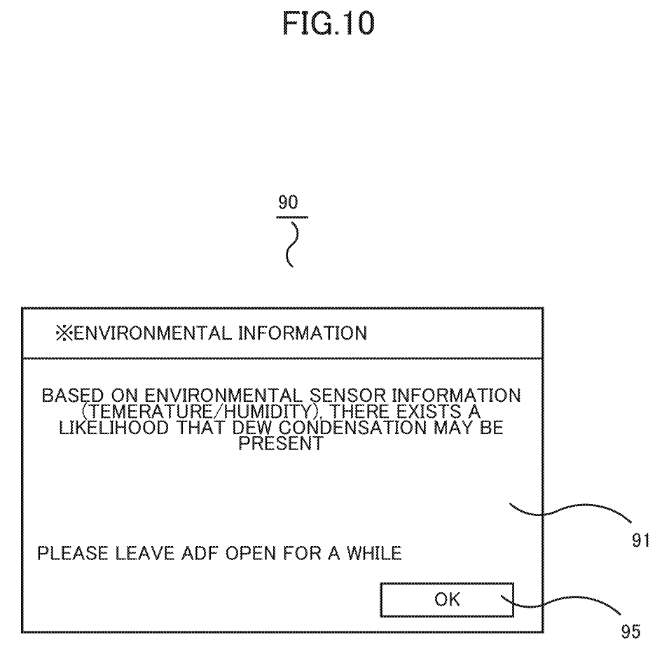

In the process of STEP S107, since, based on the environmental information at the time of the expiration of the predetermined time duration since the activation, it is a state in which it is highly likely that the dew condensation may have already occurred, the reader CPU 301 displays the indication prompting the opening of the ADF 200 on the display unit 91 for the elimination of the dew condensation (STEP S107). Details of the process of STEP S107 will be described using FIG. 10.

FIG. 10 is a diagram illustrating an example of the indication displayed on the display unit 91 for prompting the opening of the ADF 200 for the elimination of the dew condensation. As illustrated in FIG. 10, since there exists a likelihood that the dew condensation may have already occurred on the platen glass 101 (refer to FIG. 2), the reader CPU 301 displays the indication prompting the opening of the ADF 200 for the elimination of the dew condensation on the display unit 91. In addition, the reader CPU 301 displays the OK button 95, which is a button for accepting a termination operation of terminating the indication prompting the opening of the ADF 200 for the elimination of the dew condensation, on the display unit 91.

Since there exists a likelihood that the dew condensation may have already occurred on the platen glass 101, as the indication prompting the opening of the ADF 200 for the elimination of the dew condensation, for example, the following indication may be displayed: “Based on environmental sensor information (temperature/humidity), there exists a likelihood that the dew condensation may be present on the platen glass.” In addition, as the indication prompting the opening of the ADF 200 for the elimination of the dew condensation, for example, an indication such as “Please leave the ADF open for a while” is displayed. This indication prompting the opening of the ADF 200 for the elimination of the dew condensation illustrated in FIG. 10 serves as a second indication in this embodiment.

After executing the processes of STEPS S106 and S107, the reader CPU 301 determines whether or not the OK button has been pressed (STEP S108). In this process, in a case where it is determined that the OK button has not been pressed (STEP S108: No), the reader CPU 301 determined whether or not the ADF 200 has been opened (STEP S109). In this process, the reader CPU 301 determines whether or not the pressure plate open/close sensor 314 has detected that the ADF 200 has transitioned to the open state.

In the process of STEP S109, in a case where it is determined that the ADF 200 has not been opened (STEP S109: No), the reader CPU 301 determines whether or not the predetermined time duration has elapsed (STEP S110). In this process, in a case where it is determined that the predetermined time duration has not elapsed (STEP S110: No), the reader CPU 301 determines that the indication prompting the opening of the ADF 200 for the dew condensation prevention is being displayed on the display unit 91. Then, since the reader CPU 301 has not executed the process of STEP S105 and has not determined whether or not to display the indication prompting the opening of the ADF 200 for the elimination of the dew condensation, the reader CPU 301 returns the process to STEP S104. On the other hand, in a case where it is determined that the predetermined time duration has elapsed (STEP S110: Yes), the reader CPU 301 determines that the process of STEP S105 has been already executed and returns the process to STEP S108.

In the process of STEP S108, in a case where it is determined that the OK button has been pressed (STEP S108: Yes), or, in the process of STEP S109, in a case where it is determined that the ADF 200 has been opened (STEP S109: Yes), the reader CPU 301 advances the process to STEP S111. In the process of STEP S111, the reader CPU 301 erases the indication prompting the opening of the ADF 200 for the dew condensation prevention or the indication prompting the opening of the ADF 200 for the elimination of the dew condensation, which is displayed on the display unit 91 (STEP S111). In this process, the reader CPU 301 determines that the user has recognized the likelihood of the dew condensation occurring or the dew condensation occurrence and has taken the countermeasures against the dew condensation by operating the OK button 95 or opening the ADF 200. Then, the reader CPU 301 erases the indication prompting the opening of the ADF 200 for the dew condensation prevention or the indication prompting the opening of the ADF 200 for the elimination of the dew condensation, which is displayed on the display unit 91, and ends the processes relating to the countermeasures against the dew condensation prevention and the dew condensation occurrence.

As described above, in this embodiment, the environmental information, including the temperature and humidity outside the apparatus detected by the environment sensor 313 is acquired by the reader CPU 301, serving as the first controller. Then, in the case where the temperature of the environmental information is equal to or less that the threshold value T_{L} and the humidity is equal to or greater than the threshold value H_{H}, the reader CPU 301 is configured to perform the opening of the ADF 200 through displaying the indication prompting the opening of the ADF 200 on the display unit 91. This reader CPU 301, serving as the first controller, constitutes a controller in this embodiment.

### Summary of This Embodiment

In other words, the image reading apparatus 100 of this embodiment displays the indication on the display unit 91 corresponding to each of the following conditions based on the environmental information detected by the environmental sensor 313: in the case where there exists a likelihood of the dew condensation occurring, and in the case where the dew condensation is occurring. On the other hand, in the case where the temperature of the environmental information is equal to or greater than the threshold value T_{L} or the humidity is equal to or less than the threshold value H_{H}, the reader CPU 301 does not display the indication prompting the opening of the ADF 200. Thereby, the image reading apparatus 100 can facilitate the prevention of the dew condensation which occurs on the platen glass 101, and, even in a case where the dew condensation has occurred on the platen glass 101, can facilitate the elimination of the dew condensation which has occurred.

As described above, the reader CPU 301 of this embodiment causes the display unit 91 to display the indication prompting the opening of the ADF 200 for the dew condensation prevention until the predetermined time duration elapses from the case where the temperature of the environmental information has been equal to or less than the threshold value T_{L} and the humidity has been equal to or greater than the threshold value H_{H}. In the case where, after the expiration of the predetermined time duration, the reader CPU 301 has acquired the environmental information in which the temperature is equal to or greater than the threshold value T_{H} and the humidity is equal to or greater than the threshold value H_{L}, the reader CPU 301 switches the indication from one that prompts the opening of the ADF 200 for the dew condensation prevention to one that prompts the opening of the ADF 200 for the elimination of the dew condensation.

With this configuration, the image reading apparatus 100 can implement the countermeasures against the dew condensation that occurs within the image reading apparatus 100 without adding heaters and fans, and it is possible to suppress increases in the number of components and associated costs related to the countermeasures against the dew condensation that occurs in the image reading apparatus 100.

In addition, in the case where the ADF 200 has been opened, the reader CPU 301 is configured to terminate the indication prompting the opening of the ADF 200 for the dew condensation prevention or the indication prompting the opening of the ADF 200 for the elimination of the dew condensation, which is displayed on the display unit 91.

With this configuration, the image reading apparatus 100 can terminate the indication on the display unit 91 for prompting the opening of the ADF 200 at the appropriate timing at which the user has opened the ADF 200 for the countermeasures against the dew condensation, and, thereby, it is possible to improve usability.

In addition, in the state of displaying the indication on the display unit 91 for prompting the opening of the ADF 200 for the dew condensation prevention or for prompting the opening of the ADF 200 for the elimination of the dew condensation, the reader CPU 301 of this embodiment is displaying the OK button 95 on the display unit 91. In the case where the OK button 95 is pressed, the reader CPU 301 terminates the indication on the display unit 91 for prompting the opening of the ADF 200 for the dew condensation prevention or for prompting the opening of the ADF 200 for the elimination of the dew condensation.

With this configuration, the image reading apparatus 100 can terminate the indication displayed on the display unit 91 for prompting the opening of the ADF 200 at the appropriate timing at which the user has recognized the need to open the ADF 200 for the countermeasures against the dew condensation, and, thereby, it is possible to improve usability.

In addition, the reader CPU 301 of this embodiment is configured to execute the processes relating to the countermeasures against the dew condensation prevention and the dew condensation occurrence illustrated in FIG. 6 by using the environmental information from the environmental sensor 313 which the control unit 1032 utilizes for the heating control of the fixing unit 1029.

In other words, the image reading apparatus 100 of this embodiment is configured to perform a determination as to whether or not it is a case where there exists a likelihood of the dew condensation occurring or where the dew condensation is occurring, by utilizing the environmental information acquired for the heating control of the fixing unit 1029.

With this configuration, the image reading apparatus 100 can implement the countermeasures against the dew condensation that occurs in the image reading apparatus 100 without disposing a new environmental sensor in the image reading apparatus 100, and it is possible to suppress increases in the number of components and associated costs.

As described above, the image reading apparatus 100 acquires the environmental information of the temperature and humidity, and performs notification prompting the opening of the ADF 200 based on the acquired environmental information.

Therefore, the image reading apparatus 100 of this embodiment can facilitate the user in opening the ADF 200 in the case where there exists a likelihood of the dew condensation occurring, or where the dew condensation is occurring. In other words, the image reading apparatus 100 can facilitate the prevention of the dew condensation that occurs on the platen glass 101, and, even in the case where the dew condensation has occurred on the platen glass 101, can facilitate the elimination of the dew condensation which has occurred.

With this configuration, the image reading apparatus 100 can implement the countermeasures against the dew condensation that occurs in the image reading apparatus 100 without adding heaters and fans, and it is possible to suppress increases in the number of components and associated costs relating to the countermeasures against the dew condensation that occurs in the image reading apparatus 100.

### Modification Examples

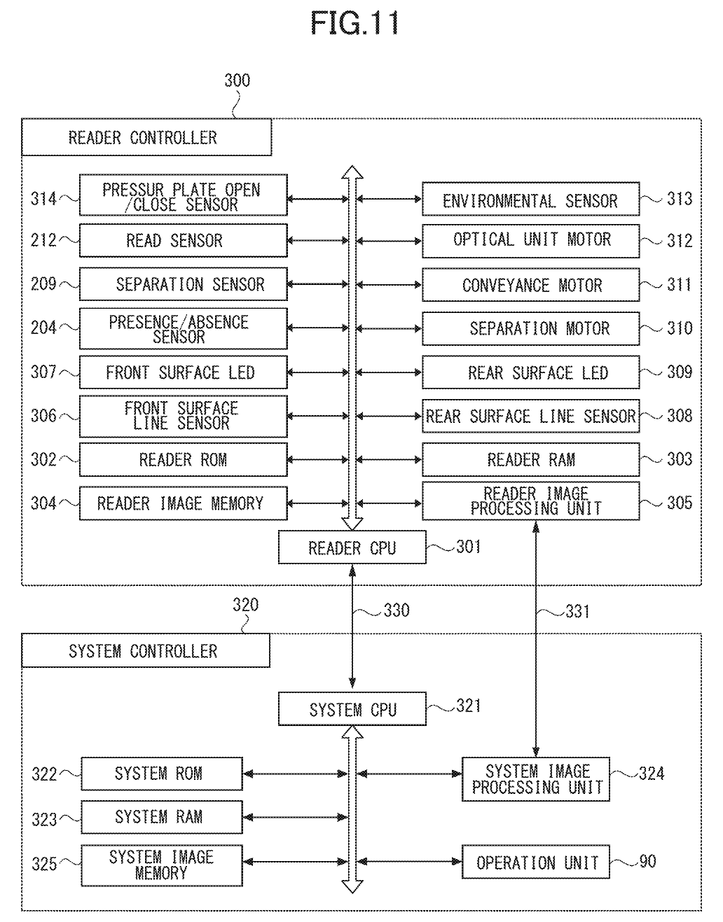

To be noted, in this embodiment, the environmental sensor 313 is disposed in the printer body 1001A of the printer 1001, and is connected to the control unit 1032 of the printer controller 340; however, it is not limited to this. For example, as illustrated in FIG. 11, the environmental sensor 313 may be disposed in the image reading apparatus 100, and may be connected to the reader CPU 301 of the reader controller 300.

In addition, in this embodiment, the reader CPU 301 acquires the environmental information including both the temperature and humidity outside the apparatus detected by the environmental sensor 313, and executes the processes relating to the countermeasures against the dew condensation prevention and the dew condensation occurrence; however, it is not limited to this. The reader CPU 301 may be configured to acquire the environmental information including at least one of the temperature and humidity, based on the acquired environmental information, execute the processes relating to the countermeasures against the dew condensation prevention and the dew condensation occurrence, and display the indication prompting the opening of the ADF 200 on the display unit 91. For example, the reader CPU 301 may be configured to acquire the temperature detected by the environmental sensor 313 as the environmental information, and, based on the acquired environmental information, display the indication prompting the opening of the ADF 200 on the display unit 91.

In particular, in the process of STEP S103 in the processes relating to the countermeasures against the dew condensation prevention and the dew condensation occurrence illustrated in FIG. 6, the reader CPU 301 may be configured to determine whether or not the temperature upon the activation is equal to or less than the threshold value T_{L}. In addition, in the process of STEP S105 in the processes relating to the countermeasures against the dew condensation prevention and the dew condensation occurrence illustrated in FIG. 6, the reader CPU 301 may be configured to determine whether or not the temperature after the expiration of the preset time duration is equal to or greater than the threshold value T_{H}.

With this configuration, the image reading apparatus 100 can facilitate the user in opening the ADF 200 in the case where there exists a likelihood of the dew condensation occurring, or where the dew condensation is occurring, through a simplified process using only the temperature data. In other words, through the simplified process using only the temperature data, the image reading apparatus 100 can facilitate the prevention of the dew condensation that occurs on the platen glass 101, and, even in the case where the dew condensation has occurred on the platen glass 101, can facilitate the elimination of the dew condensation that has occurred.

With this configuration, the image reading apparatus 100 can implement the countermeasures against the dew condensation that occurs in the image reading apparatus 100 without adding heaters and fans, and it is possible to suppress increases in the number of components and associated costs relating to the countermeasures against the dew condensation that occurs in the image reading apparatus 100.

In addition, for example, the reader CPU 301 may be configured to acquire the humidity detected by the environmental sensor 313 as the environmental information, and, based on the acquired environmental information, display the indication prompting the opening of the ADF 200 on the display unit 91.

In particular, in the process of STEP S103 in the processes relating to the countermeasures against the dew condensation prevention and the dew condensation occurrence illustrated in FIG. 6, the reader CPU 301 may be configured to determine whether or not the humidity upon activation is equal to or greater than the threshold value H_{H}. In addition, in the process of STEP S105 in the processes relating to the countermeasures against the dew condensation prevention and the dew condensation occurrence illustrated in FIG. 6, the reader CPU 301 may be configured to determine whether or not the humidity after the expiration of the preset time duration is equal to or greater than the threshold value H_{L}.

By being configured as described above, the image reading apparatus 100 can facilitate the user in opening the ADF 200 in the case where there exists a likelihood of the dew condensation occurring, or where the dew condensation is occurring, through a simplified process using only the humidity data. In other words, through the simplified process using only the humidity data, the image reading apparatus 100 can facilitate the prevention of the dew condensation that occurs on the platen glass 101, and, even in the case where the dew condensation has occurred on the platen glass 101, can facilitate the elimination of the dew condensation that has occurred.

With this configuration, the image reading apparatus 100 can implement the countermeasures against the dew condensation that occurs in the image reading apparatus 100 without adding heaters and fans, and it is possible to suppress increases in the number of components and associated costs relating to the countermeasures against the dew condensation that occurs in the image reading apparatus 100.

In addition, in this embodiment, the printer 1001 includes the operation unit 90 incorporating the display unit 91, serving as a notification unit; however, it is not limited to this. For example, the printer 1001 may include, as the notification unit, a speaker that prompts the opening of the ADF 200 by outputting a warning sound. In addition, the printer 1001 may be configured such that a computer connected via a local area network (LAN) serves as the notification unit by issuing to the computer a notification prompting the opening of the ADF 200.

In addition, in this embodiment, the ADF 200, serving as the opening/closing unit, is openably and closably disposed in the image reading apparatus 100; however, it is not limited to this. For example, the image reading apparatus 100 may include a pressure plate member, serving as the opening/closing unit, which is openably and closably disposed with respect to the platen glass 101 of the image reading apparatus 100, and presses the document on the platen glass 101.

In addition, in this embodiment, in the case where the temperature included in the environmental information upon the activation is equal to or less than the threshold value T_{L} and the humidity is equal to or greater than the threshold value H_{H}, the reader CPU 301 is configured to display the indication prompting the opening of the ADF 200 for the dew condensation prevention. In addition, in the case where, in the environmental information acquired after the expiration of the predetermined time duration since the image reading apparatus was activated, the temperature is equal to or greater than the threshold value T_{H} and the humidity is equal to or greater than the threshold value H_{L}, the reader CPU 301 is configured to display the indication prompting the opening of the ADF 200 for the elimination of the dew condensation. However, the configuration in which the reader CPU 301 issues the indication prompting the opening of the ADF 200 for the elimination of the dew condensation is not limited to this embodiment.

For example, in the case where the temperature included in the environmental information upon the activation of the image reading apparatus 100 is equal to or less than the threshold value T_{L} and the humidity is equal to or greater than the threshold value H_{H}, the reader CPU 301 displays the indication prompting the opening of the ADF 200 for the dew condensation prevention. Then, in the case where, in the environmental information acquired after the expiration of the predetermined time duration since the image reading apparatus was activated, the temperature is equal to or greater than the threshold value T_{H}, the reader CPU 301 may be configured to display the indication prompting the opening of the ADF 200 for the elimination of the dew condensation, regardless of humidity.

In addition, for example, in the case where the temperature included in the environmental information upon the activation of the image reading apparatus 100 is equal to or less than the threshold value T_{L} and the humidity is equal to or greater than the threshold value H_{H}, the reader CPU 301 displays the indication prompting the opening of the ADF 200 for the dew condensation prevention. Then, the reader CPU 301 may be configured such that, in the case where the user does not press the OK button 95 or open the ADF 200 before the predetermined time duration elapses, the indication prompting the opening of the ADF 200 for the elimination of the dew condensation is displayed based on the expiration of the predetermined time duration.

In other words, from the case where the temperature of the environmental information is equal to or less than the threshold value T_{L} and the humidity is equal to or greater than the threshold value H_{H}, the reader CPU 301 displays the indication prompting the opening of the ADF 200 for the dew condensation prevention on the display unit 91, until the predetermined time duration elapses. Then, after the expiration of the predetermined time duration, regardless of the temperature of the environmental information, the reader CPU 301 may be configured to switch the indication on the display unit 91 from the indication prompting the opening of the ADF 200 for the dew condensation prevention to the indication prompting the opening of the ADF 200 for the elimination of the dew condensation.

In a case of being configured as described above, since there exists a likelihood the dew condensation is occurring in the case where the predetermined time duration has elapsed in a state in which there exists a likelihood of the dew condensation occurring, the image reading apparatus 100 can facilitate the user in opening the ADF 200. In other words, in the state in which there exists a likelihood of the dew condensation occurring, the image reading apparatus 100 can facilitate the elimination of the dew condensation that occurs on the platen glass 101, through a simplified process using only the expiration of the predetermined time duration.

With this configuration, the image reading apparatus 100 can implement the countermeasures against the dew condensation that occurs in the image reading apparatus 100 without adding heaters and fans, and it is possible to suppress increases in the number of components and associated costs related to the countermeasures against the dew condensation that occurs in the image reading apparatus 100.

In addition, for example, in the case where the temperature included in the environmental information upon the activation of the image reading apparatus 100 is equal to or less than the threshold value T_{L} and the humidity is equal to or greater than the threshold value H_{H}, the reader CPU 301 displays the indication prompting the opening of the ADF 200 for the dew condensation prevention. Then, in the case where, in the environmental information acquired after the activation of the image reading apparatus 100, the temperature is equal to or greater than the threshold value T_{H}, and the humidity is equal to or greater than the threshold value H_{L}, the reader CPU 301 may be configured to display the indication prompting the opening of the ADF 200 for the elimination of the dew condensation.

In other words, in the case where the temperature of the environmental information is equal to or less than the threshold value T_{L} and the humidity is equal to or greater than the threshold value H_{H}, the reader CPU 301 displays the indication prompting the opening of the ADF 200 for the dew condensation prevention on the display unit 91. In addition, after acquiring the environmental information (first environmental information) in which the temperature is equal to or less than the threshold value T_{L} and the humidity is equal to or greater than the threshold value H_{H}, the reader CPU 301 switches the indication of the display unit 91 in accordance with the acquired environmental information (second environmental information). In the case where the reader CPU 301 has received the environmental information as the second environmental information in which the temperature is less than the threshold value T_{H} and the humidity is equal to or greater than the threshold value H_{H}, the reader CPU 301 displays the indication prompting the opening of the ADF 200 for the dew condensation prevention on the display unit 91. In addition, in the case where the reader CPU 301 has received the environmental information as the second environmental information in which the temperature is equal to or greater than the threshold value T_{H} and the humidity is equal to or greater than the threshold value H_{H}, the reader CPU 301 may be configured to cause the display unit 91 to display the indication by switching to the indication prompting the opening of the ADF 200 for the elimination of the dew condensation.

In a case of being configured as described above, in a case where a state has transitioned from a state in which there exists a likelihood of the dew condensation occurring to the state in which the temperature is equal to or greater than the threshold value T_{H} and the humidity is equal to or greater than the threshold value H_{L}, since there exists a likelihood that the dew condensation is occurring, the image reading apparatus 100 can facilitate the user to open the ADF 200. In other words, in the state in which there exists a likelihood of the dew condensation occurring, through a simplified process using only changes in the temperature and humidity, the image reading apparatus 100 can facilitate the elimination of the dew condensation that occurs on the platen glass 101.

With this configuration, the image reading apparatus 100 can implement the countermeasures against the dew condensation that occurs in the image reading apparatus 100 without adding heaters and fans, and it is possible to suppress increases in the number of components and associated costs relating to the countermeasures against the dew condensation that occurs in the image reading apparatus 100.

In addition, in this embodiment, the threshold value T_{L}, serving as the first threshold value, is set to 5°C, the threshold value H_{H}, serving as the second threshold value, is set to 80%, the threshold value T_{H}, serving as the third threshold value, is set to 25°C, and the threshold value H_{L}, serving as the fourth threshold value, is set to 60%; however, these parameters are not limited to these values. The first to fourth threshold values may be set in accordance with an office environment in which the image reading apparatus 100 is installed, taking into account low-temperature environments that may occur (for example, at the start of business hours during winter), and the subsequent elevation of room temperatures from such low-temperature environments due to the activation of air-conditioning equipment. Since the dew condensation may occur in a state in which the temperature within the apparatus falls below the dew point temperature, which is calculated based on the ambient air temperature and humidity, the first to fourth threshold values are preferably set to the temperature and humidity conditions at which the temperature within an apparatus falls below the ambient air dew point temperature.

In addition, in this embodiment, the predetermined time duration is set to 80 minutes; however, it is not limited to this. The predetermined time duration may be set based on the duration required for the air conditioning equipment to complete the elevation of the room temperature from a possible low-temperature environment in an office, in which the image reading apparatus 100 is installed.

In addition, in this embodiment, using the temperature of the environmental information which the environmental sensor 313 has detected, the printer 1001 performs the processes relating to the countermeasures against the dew condensation prevention and the dew condensation occurrence illustrated in FIG. 6, and the heating control of the fixing unit 1029; however, it is not limited to this. For example, the printer 1001 may be configured to include an environmental sensor separate from the environmental sensor 313, which performs the heating control of the fixing unit 1029, so as to perform the processes relating to the countermeasures against the dew condensation prevention and the dew condensation occurrence illustrated in FIG. 6.

Even in a case of being configured as described above, the printer 1001 can implement the countermeasures against the dew condensation that occurs in the image reading apparatus 100 without adding heaters and fans, and it is possible to suppress increases in the number of components and associated costs relating to the countermeasures against the dew condensation that occurs in the image reading apparatus 100.

In addition, in this embodiment, the printer 1001 includes the OK button 95 for accepting the termination operation of terminating the indication prompting the opening of the ADF 200 for the dew condensation prevention and the indication prompting the opening of the ADF 200 for the elimination of the dew condensation; however, it is not limited to this. The printer 1001 may include an operation button for accepting the termination operation in the set of operation keys 92, serving as the input portion. In addition, for example, the printer 1001 may be configured such that the termination operation is input from a computed connected via a LAN.

In addition, in this embodiment, within the printer 1001, the operation unit 90 including the display unit 91 is disposed in the automatic image reading apparatus 10; however, it is not limited to this. For example, the printer 1001 may be configured such that the display unit is included in the printer body 1001A. In addition, for example, the printer 1001 may be configured to display on a computer, which is connected via a LAN, the indication prompting the opening of the ADF 200 for the dew condensation prevention and the indication prompting the opening of the ADF 200 for the elimination of the dew condensation. In a case of being configured as described above, such a computer serves as the display unit.

In addition, in this embodiment, the printer 1001 includes one image forming unit 1033, and is configured to perform monochrome printing; however, it is not limited to this. For example, the printer 1001 may be configured as a four-drum full-color system, and may include four image forming units that form the toner images of four colors: yellow (Y), magenta (M), cyan (C), and black (K).

In a case of being configured as described above, the control unit 1032 may be configured to perform color shift correction control, such as adjusting an image forming speed of the image forming unit 1033 based on the detection results acquired by the environmental sensor 313, in order to prevent color shift caused by temperature fluctuations.

In addition, in this embodiment, in the printer 1001, the reader CPU 301 is configured to perform the processes relating to the countermeasures against the dew condensation prevention and the dew condensation occurrence illustrated in FIG. 6; however, it is not limited to this. For example, in the printer 1001, the system CPU 321 may be configured to perform the processes relating to the countermeasures against the dew condensation prevention and the dew condensation occurrence illustrated in FIG. 6, and the second controller may constitute the controller. In addition, for example, in the printer 1001, the control unit 1032 may be configured to perform the processes relating to the countermeasures against the dew condensation prevention and the dew condensation occurrence illustrated in FIG. 6. In other words, in the printer 1001, the controller that performs the processes relating to the countermeasures against the dew condensation prevention and the dew condensation occurrence illustrated in FIG. 6 may be constituted from the second controller.

In addition, in this embodiment, the control unit 1032 performs the control of the heating temperature of the fixing unit 1029 using the temperature of the environmental information acquired by the environmental sensor 313; however, it is not limited to this. For example, in a case where the printer 1001 includes fans, the control unit 1032 may be configured to perform the drive control of such fans using the temperature of the environmental information detected by the environmental sensor 313.

In addition, in this embodiment, the front surface reading unit 103 and the rear surface reading unit 216 are described for the case where optical systems provided in these reading units utilize reduction optic systems that focus the reflected light from the document onto the front surface line sensor 306 and the rear surface line sensor 308; however, it is not limited to this. The optical systems provided in the front surface reading unit 103 and the rear surface reading unit 216 may be equal magnification optical systems that focus the reflected light from the document onto a contact image sensor (CIS).

According to this disclosure, it is possible to suppress increases in the number of components and associated costs relating to the countermeasures against the dew condensation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2024-198204, filed November 13, 2024, which is hereby incorporated by reference herein in its entirety.

What is claimed is:

1. An image reading apparatus comprising:
a transparent member;
a reading unit configured to read an image on a document through the transparent member;
an opening/closing unit disposed to be openable and closable with respect to the transparent member; and
a controller configured to acquire environmental information including at least one of temperature and humidity, and configured to cause a display unit to display an indication prompting an opening of the opening/closing unit based on the environmental information.

2. The image reading apparatus according to claim 1, wherein the environmental information includes both the temperature and the humidity, and
wherein the controller is configured, in a case where the temperature of the environmental information is equal to or less than a first threshold value and the humidity of the environmental information is equal to or greater than a second threshold value, to cause the display unit to display the indication prompting the opening of the opening/closing unit.

3. The image reading apparatus according to claim 2, wherein the controller is configured to cause the display unit to display a first indication prompting the opening of the opening/closing unit for preventing dew condensation and a second indication prompting the opening of the opening/closing unit for eliminating dew condensation.

4. The image reading apparatus according to claim 3, wherein the controller is configured to cause the display unit to display the first indication until a predetermined time duration elapses from a case where the temperature of the environmental information has been equal to or less than the first threshold value and the humidity of the environmental information has been equal to or greater than the second threshold value, and, after the predetermined time duration has elapsed, is configured to switch the first indication to the second indication and display the second indication on the display unit.

5. The image reading apparatus according to claim 3, wherein the controller is configured to
(i) cause the display unit to display the first indication in a case where, after the temperature of the environmental information has been equal to or less than the first threshold value and the humidity of the environmental information has been equal to or greater than the second threshold value, the temperature of the environmental information is less than a third threshold value that is greater than the first threshold value, and
(ii) switch the first indication to the second indication and display the second indication on the display unit, in a case where, after the temperature of the environmental information has been equal to or less than the first threshold value and the humidity of the environmental information has been equal to or greater than the second threshold value, the temperature of the environmental information is equal to or greater than the third threshold value.

6. The image reading apparatus according to claim 3, wherein the controller is configured to
(i) cause the display unit to display the first indication until a predetermined time duration elapses from a case where the temperature of the environmental information has been equal to or less than the first threshold value and the humidity of the environmental information has been equal to or greater than the second threshold value, and
(ii) switch the first indication to the second indication and display the second indication on the display unit, in a case where, after the predetermined time duration has elapsed, the temperature of the environmental information is equal to or greater than a third threshold value that is greater than the first threshold value.

7. The image reading apparatus according to claim 1, wherein the controller is configured to terminate the indication prompting the opening of the opening/closing unit in a case where, after causing the display unit to display the indication prompting the opening of the opening/closing unit, the opening/closing unit is opened.

8. The image reading apparatus according to claim 1, wherein the controller is configured to
(i) receive a termination operation of terminating the indication prompting the opening of the opening/closing unit on the display unit, and
(ii) terminate the indication prompting the opening of the opening/closing unit in a case where the controller receives the termination operation.

9. The image reading apparatus according to claim 1, wherein the environmental information includes the temperature, and
wherein the controller is configured to cause the display unit to display the indication prompting the opening of the opening/closing unit in a case where the temperature of the environmental information is equal to or less than a first threshold value.

10. The image reading apparatus according to claim 1, wherein the environmental information includes the humidity, and
wherein the controller is configured to cause the display unit to display the indication prompting the opening of the opening/closing unit in a case where the humidity of the environmental information is equal to or greater than a second threshold value.

11. An image forming apparatus comprising:
an image reading apparatus configured to read an image on a document;
an image forming apparatus body configured to form the image on a recording medium; and
a display unit configured to display information,
wherein the image reading apparatus includes:
a transparent member;
a reading unit configured to read the image on the document through the transparent member;
an opening/closing unit disposed to be openable and closable with respect to the transparent member; and
a first controller configured to transmit image information that has been read by the reading unit,
wherein the image forming apparatus body includes:
an environmental sensor configured to detect environmental information including at least one of temperature and humidity;
a second controller configured to receive the image information transmitted by the first controller; and
an image forming unit configured to form the image on a sheet based on the image information received by the second controller, and
wherein the first controller is configured to cause the display unit to display an indication prompting an opening of the opening/closing unit.

12. The image forming apparatus according to claim 11, wherein the image forming apparatus body includes a fixing unit configured to fix the image, which has been formed by the image forming unit, on the sheet by heating and pressing the image, and
wherein the second controller is configured to control a temperature at which the fixing unit heats, using the environmental information detected by the environmental sensor.

13. An image forming apparatus comprising:
an image reading apparatus configured to read an image on a document;
an image forming apparatus body configured to form the image on a recording medium; and
a display unit configured to display information,
wherein the image reading apparatus includes:
a transparent member;
a reading unit configured to read the image on the document through the transparent member;
an opening/closing unit disposed to be openable and closable with respect to the transparent member; and
a first controller configured to transmit image information that has been read by the reading unit,
wherein the image forming apparatus body includes:
an environmental sensor configured to detect environmental information including at least one of temperature and humidity;
a second controller configured to receive the image information transmitted by the first controller; and
an image forming unit configured to form the image on a sheet based on the image information received by the second controller, and
wherein the second controller is configured to cause the display unit to display an indication prompting an opening of the opening/closing unit based on the environmental information.

14. The image forming apparatus according to claim 13, wherein the image forming apparatus body includes a fixing unit configured to fix the image, which has been formed by the image forming unit, on the sheet by heating and pressing the image, and
wherein the second controller is configured to control a temperature at which the fixing unit heats, using the environmental information detected by the environmental sensor.
